(19) United States
(12) Patent Application Publication
(10) Pub. No.: US 2026/0175517 A1
(43) Pub. Date: Jun. 25, 2026

(54) SYSTEMS AND METHODS FOR FORMING MATERIALS USING ELECTROSTATICALLY PUMPED REGOLITH OR OTHER PARTICULATE MATTER

(71) Applicant: Blue Origin, LLC, Kent, WA (US)

(72) Inventor: Michael L. Gernhardt, Houston, TX (US)

(21) Appl. No.: 18/989,441

(22) Filed: Dec. 20, 2024

(51) Int. Cl. B29C 64/321; B33Y 30/00; B33Y 40/00

(52) U.S. Cl. CPC B29C 64/321; B33Y 30/00; B33Y 40/00

(57) ABSTRACT

Systems and methods of operation for a pump for pumping charged particulate matter, such as lunar dust, are described. The pump may operate with no moving parts. Instead, the pump operates by selectively activating and deactivating each of a series of electrical circuits to control the presence or absence of electric fields applied to the lunar dust. The pumped lunar dust may be combined with a melding material to produce a construction material that may be used for a 3D-printing type of construction or assembly. The pumped lunar dust may alternatively be used as thrust in a propulsion system.

### BACKGROUND

Lunar regolith is the layer of unconsolidated material covering almost the entire surface of the Moon. Lunar dust, among the regolith, is known to be negatively charged from the constant bombardment of electrons and protons from the solar wind. Because of this electrostatic charge, lunar dust can stick to most objects that are not grounded. The small particles can adhere to space-suits, tools, equipment, polished reflectors, solar cells, and telescope lenses, for example. Lunar dust may also erode bearings, gears, and other mechanical mechanisms that are not sufficiently sealed.

The negative electrostatic charge on the dust particles in the lunar vacuum causes them to repel one another so as to minimize their electrostatic potential. This may result in a layer of suspended dust about one meter above the lunar surface. During the Apollo 17 lunar landing, the charged dust was attracted to the astronauts'spacesuits, equipment, and the lunar buggy, leading to operational difficulties. The dust accumulated on the spacesuits caused reduced visibility for the astronauts and was unavoidably transported inside the spacecraft where it caused breathing irritation, among other things.

### SUMMARY

Systems and methods for operating a pump designed to transport charged lunar dust or other powder-like or particulate substances are disclosed. This pump functions without moving parts, relying instead on the selective activation and deactivation of a series of electrical circuits to generate and control electric fields applied to the particulate material, such as lunar dust or manufacturing powders, for example. The transported material can be combined with a binding agent to create a construction material suitable for 3D printing or assembly applications. Alternatively, the pumped particulate matter may be utilized as propellant in a propulsion system.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 schematically illustrates an electrostatically pumped stream of charged lunar dust combined with a melding material to form a construction compound, according to some embodiments.

FIG. 2 schematically illustrates an electrostatically pumped and focused stream of charged lunar dust combined with a melding material to form a construction compound, according to some embodiments.

FIG. 3 schematically illustrates an electrostatically pumped stream of charged lunar dust sintered with microwave energy to form a construction compound, according to some embodiments.

FIG. 4 schematically illustrates a portion of an apparatus for electrostatically pumping charged lunar dust, according to some embodiments.

FIG. 5 is a schematic cross-section view of a sequence of energizing electrodes for electrostatically pumping charged lunar dust, according to some embodiments.

FIGS. 6-11 are timing diagrams of voltage applied to electrodes for electrostatically pumping charged lunar dust, according to some embodiments.

### DETAILED DESCRIPTION

This disclosure describes systems and methods for electrostatically producing a stream of charged particulate matter, which may be lunar dust. In some embodiments, such a stream may be combined with an additive, herein called a melding material, to create a construction material. A region where this combining occurs is herein called a material fabricating region, and it may be at or near the output of the stream of charged lunar dust, for example. In other embodiments, the stream may be used for propulsion (e.g., thrust) or dust collection and removal, as described below.

Systems described herein are capable of transporting a powder or powder-like substance bearing an electrical charge that enables motion through an electrostatic pump. Such substances include, but are not limited to, particulate materials that can be effectively manipulated using electrostatic forces. One primary example is lunar regolith, a naturally occurring fine, granular material on the Moon's surface that may be charged due to its dielectric properties. This property allows it to be electrostatically pumped, where the selective activation of electric fields facilitates its controlled movement, as described below.

In addition to lunar regolith, other examples of substances that may be electrostatically pumped as described herein include additive manufacturing powder feedstock, such as charged metal, ceramic, or polymer powders used in Earth-based 3D printing technologies. These powders, when electrostatically charged, have properties that allow for control and movement within an electrostatic field. Other materials, such as fine volcanic ash, pulverized minerals, or electrically charged dust in industrial applications may be utilized in systems described herein. The systems described herein may be adapted for use (e.g., in construction, resource processing, propulsion, etc.) in various environments, including Earth, the Moon, Mars, just to name a few examples.

Electrostatically producing a stream of charged particulate matter, such as lunar dust, may involve a pump. In particular, such a pump may operate with no moving parts and instead operate by selectively activating and deactivating each of a series of electrical circuits to control the presence or absence of electric fields along a length of the pump and applied to the lunar dust. Herein, pumping refers to the action of conveying (e.g., moving, transferring, causing to flow) a stream of particles from one location to another location by providing a force to act on the stream of particles. For example, pumping may involve using a Coulomb force to move charged dust particles through a tube or pipe to transfer the dust a substantial distance.

Lunar regolith, which may be described as particulate matter, includes smaller-grained “soil” among the large pebbles, rocks and boulders. The soil may generally include a heterogenous mix of rock fragments, minerals, glass, and glass-bonded aggregates. The lunar soil is very fine and therefore often referred to as “dust”. Representative samples collected during Apollo missions show a median particle size between about 40 μm and 130 μm, and with particles smaller than 20 μm representing 10% to 20% of the weight, for example. Minerals and glass of the dust form grains with sharp and serrated edges due to their brittle nature, leading to the abrasive nature of the dust. Due to constant solar wind plasma impingement, cosmic ray spallation, solar UV, and X-ray radiation, the dust may also be also electrostatically charged. Certain characteristics of the lunar environment (e.g., vacuum) and regolith generally lead to a relatively large build-up and retention of electrical charge. This build-up of charge causes dust particles to adhere easily to surfaces and may also cause the dust to float above the lunar surface. The lunar dust is primarily negatively charged.

A stream of charged lunar dust may be produced by sequentially energizing electrodes that are placed in a direction of the stream. The energized electrodes may attract or repel the charged dust particles via the Coulomb force. For example, a positively charged electrode will attract a negatively charged dust particle. The attraction will lead to an acceleration of the dust particle, which consequently has momentum and inertia. Accordingly, even if the electrode ceases to attract the dust particle (e.g., a positive voltage applied to the electrode is subsequently removed or grounded), the dust particle may continue moving, albeit while no longer accelerating, in its trajectory. Once the dust particle has travelled a sufficiently large distance past the electrode, a subsequent electrode ahead of the dust particle may be energized to further accelerate the dust particle. In a sense, this is a process of a charged dust particle being “handed off” from one electrode to the next to impart a forward motion of the dust particle. Such a process is described below in relation to various example embodiments.

In some embodiments, a pump for conveying lunar dust comprises electrodes configured to be sequentially energized to produce an electric field among the dust to create a force imbalance on the dust so as to convey the dust in a particular direction. The pump may include a vessel, such as a tube, pipe, or conduit for conveying the lunar dust. An input port of the vessel may be where the lunar dust enters the vessel, and an output port may be where the lunar dust exits the vessel. For example, the input port of the vessel may be the entrance of a pipe. The pump may include electronics to sequentially energize the electrodes. Such sequential energizing is described below.

In some embodiments, the electronics may be configured to vary the frequency or time period during which the electrodes are sequentially energized based, at least in part, on flow speed of the lunar dust. For example, individual electrodes among a series of electrodes may be individually energized at different times (in sequence) to create an electric field for a particular time span, which may be varied. Flow speed of the dust stream may correspond to this particular time span. In this way, dust flow speed may be adjusted by varying the time span during which each of the electrodes are energized. One or more sensors may be included in a pump to measure speed and/or volume, for example, of the dust flow in the pump vessel. For example, a magnetometer may be used to measure a magnetic field created by moving charged lunar dust particles in the vessel of the pump. The magnitude of the magnetic field may depend on the flow rate (e.g., velocity, cross-sectional area of flow, particle density, and so on) of the charged dust stream.

In some embodiments, the electronics may be configured to reverse the sequence of energizing the electrodes to stop or reverse direction of flow of the lunar dust. For example, if the electrodes are sequentially energized in a particular order (e.g., 1, 2, 3, . . . ) to pump lunar dust in a particular direction, then reversing the particular order (e.g., . . . , 3, 2, 1) may result in the pump reversing the flow direction. This principle of operation may be useful for relatively quickly slowing or stopping dust flow.

In some embodiments, an electrostatic pump system for producing and guiding a stream of charged lunar dust into a material fabricating region may include a vessel for conveying the charged lunar dust. The vessel may have an input port and an output port for the charged lunar dust. The material fabricating region may be located at the output port of the vessel and may be configured to facilitate a solidification process of the stream of the charged lunar dust via an interaction between the stream of the charged lunar dust and a melding material or electromagnetic radiation.

In addition to the vessel, the electrostatic pump system also includes a first electrode and a second electrode located along a length of the vessel, wherein the first electrode is located closer than the second electrode to the input port and the second electrode is located closer than the first electrode to the output port. Generally, an electrostatic pump may have more than two electrodes, but these example embodiments are useful for demonstrating principles of operation of some of the pumps described herein. The system includes electronics to energize the first electrode and the second electrode sequentially such that i) the first electrode, when energized, applies a force on the charged lunar dust to convey the charged lunar dust from the input port of the vessel and toward the first electrode, and ii) the second electrode, when energized, applies a force on the charged lunar dust to convey the charged lunar dust away from the first electrode and toward the output port of the vessel. As mentioned above, the system may include additional electrodes that operate in a similar manner.

In some implementations, the electrostatic pump system may also include a nozzle to output melding material into the material fabricating region. The melding material may be a polymer, for example. In other implementations, the electrostatic pump system may include a microwave emitter to output microwave radiation or a laser to produce relatively intense electromagnetic radiation in the material fabricating region.

In some embodiments, the vessel of the electrostatic pump system may include focusing electrodes at or near the output port of the vessel. The focusing electrodes may be configured to focus the stream of the charged lunar dust, as described below.

In some embodiments, the vessel of the electrostatic pump system may include an electrode screen at the input port of the vessel. The electrode screen may be configured to electrostatically attract and transmit the charged lunar dust from outside the vessel to inside the vessel, as described below. The electronics of the system may be configured to energize the electrode screen, the first electrode, and the second electrode sequentially such that the first electrode electrostatically attracts the charged lunar dust from the electrode screen toward the first electrode. The electronics may also be configured to vary how long the first electrode and the second electrode are energized based, at least in part, on flow speed of the charged lunar dust. Further, the electronics may be configured to reverse the sequence of energizing the first electrode and the second electrode to stop or reverse the direction of flow of the charged lunar dust.

In some embodiments, to produce a stream of charged lunar dust, a material fabrication system may include an electrostatic pump system that includes a vessel and a series of electrodes located along a length of the vessel. The series of electrodes may be configured to be sequentially energized to apply electrostatic forces on the charged lunar dust. To fabricate the material, in one implementation, a dispenser may be located at or near an output port of the vessel to provide a melding material to the stream of the charged lunar dust. In another implementation, a microwave emitter may be located at or near the output port to radiate the stream of the charged lunar dust. In some implementations, the electrostatic pump system may include focusing electrodes at the output port of the vessel and/or an electrode screen at the input port of the vessel.

In some embodiments an electrostatic pump system may be configured to produce a jet of charged lunar dust. The electrostatic pump system may include a vessel for accelerating the charged lunar dust, the vessel having an input port and an output port. The system may further include a series of electrodes located along a length of the vessel. The series of electrodes may be configured to be sequentially energized to apply electrostatic forces on the charged lunar dust to accelerate the charged lunar dust in a direction from the input port to the output port. The individual electrodes of the series of electrodes may be progressively longer in the direction from the input port to the output port. The increasing length of the individual electrodes may correspond to the acceleration of the charged lunar dust. The system may include focusing electrodes at the output port of the vessel, wherein the focusing electrodes may be configured to focus the accelerated charged lunar dust to form the jet of the charged lunar dust, which may be used as thrust in a propulsion system, for example. The system may further include an electronic control system to vary lengths of time that the individual electrodes of the series of electrodes are energized based, at least in part, on flow speed of the charged lunar dust.

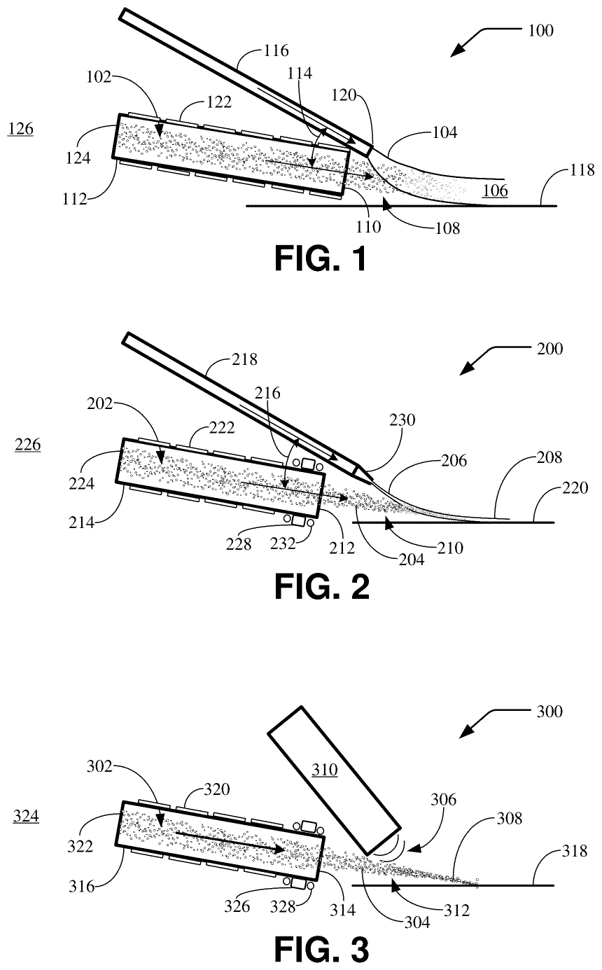

FIG. 1 schematically illustrates an electrostatic pump system 100 pumping a stream of charged lunar dust 102, which is subsequently combined with a melding material 104 to form a construction compound 106, according to some embodiments. As explained above, lunar dust 102 may comprise negatively charged dust particles, and this will be taken as the case for example embodiments described herein, though claimed subject matter is not limited to particles having negative charge or having a lunar origin. The stream of charged lunar dust 102 may be combined with melding material 104 in a space herein called a material fabricating region, which is identified as 108 in FIG. 1. Material fabricating region 108 may be at or near an output port 110 of a vessel 112 that pumps charged lunar dust 102. In material fabricating region 108, charged lunar dust 102 may be intermixed with melding material 104 by directing the two substances into each other at an angle 114 between an axis of vessel 112 and an injector 116 of the melding material, for example. Angle 114 may range from around 10 to 90 degrees or greater. Angle 114 and relative flow rates, volumes, and cross-sections of the stream of charged lunar dust and the melding material may generally affect the intermixing process and outcome. A substantial mixing of the two substances may result in formation of construction compound 106, which may be deposited onto a surface 118.

In various implementations, melding material 104 may be a paste, slurry, liquid, gas, plasma, or a combination of these types of substances. For example, melding material 104 may be a polymer such as an epoxy resin or a thermoplastic. In another example, sulfur, which may be available in lunar regolith, may be used to create sulfur-based polymers. Melding material 104 may be configured to chemically and/or physically react with charged lunar dust 102. In some implementations, melding material 104 may be positively charged to substantially neutralize the negatively charged lunar dust.

Generally, temperature and the vacuum of the Moon may affect melding material 104. For example, the melding material may outgas relatively quickly as it exits a nozzle 120 of injector 116. The temperature and pressure of the melding material may be controlled inside injector 116, but the melding material, upon exiting nozzle 120, may be exposed to vacuum and an ambient temperature of material fabricating region 108. The type of melding material and these environmental factors may be used advantageously for the formation of a relatively strong and workable construction compound 106. The time span (e.g., setup time) between intermixing and hardening of construction compound 106 may depend, at least in part, on the type of melding material and the environmental factors of material fabricating region 108. In some implementations, construction compound 106 may be deposited onto surface 118 layer by layer, similar to or the same as a 3D printing process, or may be used as a filling material, for example. How construction compound 106 is used may at least partly depend on its setup time.

Vessel 112 may include a series of electrodes 122 located along a length of the vessel. The series of electrodes may be configured to be sequentially energized to apply electrostatic forces on the charged lunar dust, as described in detail below. The vessel may also include an electrode screen 124 at the input port of the vessel. The electrode screen may be configured to electrostatically attract and transmit charged lunar dust from outside the vessel, such as in a region 126, to inside the vessel.

FIG. 2 schematically illustrates an electrostatic pump system 200 pumping charged lunar dust 202 into a focused stream 204, which is subsequently combined with a melding material 206 to form a construction compound 208, according to some embodiments. Stream 204 of charged lunar dust 202 may be combined with melding material 206 in a material fabricating region 210, which may be at or near an output port 212 of a vessel 214 that pumps charged lunar dust 202. In material fabricating region 210, charged lunar dust 202 may be intermixed with melding material 206 by directing the two substances into each other at an angle 216 between an axis of vessel 214 and an injector 218 of the melding material, for example. Angle 216 may range from around 10 to 90 degrees or greater. Angle 216 and relative flow rates, volumes, and cross-sections of the stream of charged lunar dust and the melding material may generally affect the intermixing process and outcome. A substantial mixing of the two substances may result in formation of construction compound 208, which may be deposited onto a surface 220. In various implementations, melding material 206 may be a paste, slurry, liquid, gas, plasma, or a combination of these types of substances. Melding material 206 may be configured to chemically and/or physically react with charged lunar dust 202.

Vessel 214 may include a series of electrodes 222 located along a length of the vessel. The series of electrodes may be configured to be sequentially energized to apply electrostatic forces on the charged lunar dust. The vessel may also include an electrode screen 224 at the input port of the vessel. The electrode screen may be configured to electrostatically attract and transmit charged lunar dust from outside the vessel, such as in a region 226, to inside the vessel.

Focusing electrodes 228 may be located on or near vessel 214 at or near output port 212. The focusing electrodes may be configured to focus the stream of the charged lunar dust 202 into a beam having a relatively narrow cross section. In some implementations, to account for a smaller beam of charged lunar dust, injector 218 may include a nozzle 230 that narrows the extrusion of melding material 206. Focusing electrodes 228 may comprise one or more electrodes that produce an electric field to affect the distribution of charged lunar dust 202. In some implementations, instead of, or in addition to, focusing electrodes 228, one or more electromagnetic coils 232 may be placed at or near output port 212 to produce a magnetic field to affect the distribution of charged lunar dust 202. Such affecting is possible because the magnetic field imparts a force on each of the moving charged particles.

FIG. 3 schematically illustrates an electrostatic pump system 300 pumping charged lunar dust 302 into a focused stream 304, which is subsequently sintered with microwave energy 306 to form a construction compound 308, according to some embodiments. The microwave energy may be produced by a microwave emitter 310. Stream 304 of charged lunar dust 302 may be radiated with microwave energy 306 in a material fabricating region 312, which may be at or near an output port 314 of a vessel 316 that pumps charged lunar dust 302. In material fabricating region 312, charged lunar dust 302 may be sintered by directing microwave energy 306 into charged lunar dust 302. The flow rate, volume, and cross-section of the stream of charged lunar dust 302 and the intensity and exposure time of the microwave radiation may generally affect the process and outcome of formation of construction compound 308, which may be deposited onto a surface 318. In various implementations, the sintering may result in the construction compound being granular or a relatively continuous solid.

Vessel 316 may include a series of electrodes 320 located along a length of the vessel. The series of electrodes may be configured to be sequentially energized to apply electrostatic forces on the charged lunar dust. The vessel may also include an electrode screen 322 at the input port of the vessel. The electrode screen may be configured to electrostatically attract and transmit charged lunar dust from outside the vessel, such as in a region 324, to inside the vessel.

Focusing electrodes 326 may be located on or near vessel 316 at or near output port 314. The focusing electrodes may be configured to focus the stream of the charged lunar dust 302 into a beam having a relatively narrow cross section. Focusing electrodes 326 may comprise one or more electrodes that produce an electric field to affect the distribution of charged lunar dust 302. In some implementations, instead of, or in addition to, focusing electrodes 326, one or more electromagnetic coils 328 may be placed at or near output port 314 to produce a magnetic field to affect the distribution of charged lunar dust 302. In some implementations, instead of microwave emitter 310 producing microwave energy 306, a laser (not illustrated) may produce a beam to affect (e.g., such as sintering) the distribution of charged lunar dust 302.

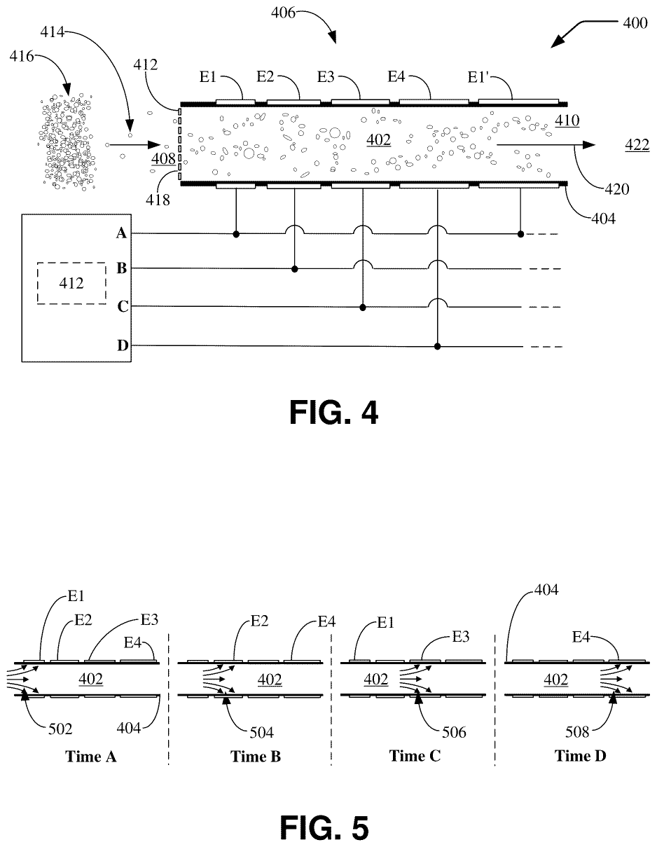

FIG. 4 schematically illustrates a portion of an electrostatic pump 400 for pumping charged lunar dust 402, according to some embodiments. Pump 400, configured for conveying (e.g., pumping) charged lunar dust 402 through a vessel 404, includes electrodes 406 individually identified as E1-E4 for description purposes (electrode E1′ will be referred to below). In some embodiments, electrodes 406 may be continuous in that each electrode circumferentially traverses vessel 404. Thus, each electrode illustrated in the top “row” is respectively the same electrode (just a different cross-section thereof) as that of the bottom “row”. Though five electrodes 406 are illustrated, pump 400 may include many more. For example, pump 400 may be a portion of a larger (e.g., longer) pump or pump section. In other embodiments, instead of each electrode 406 circumferentially traversing vessel 404, the electrodes may be discrete in that they comprise multiple individually-energizeable electrodes positioned around the circumference of vessel 404. For example, each of E1-E4 in FIG. 4 may comprise several or more individual discrete electrodes that each only cover a portion of the circumference of vessel 404.

Vessel 404 may be a tube, pipe, or conduit for conveying the lunar dust. An input port 408 of vessel 404 may be where lunar dust 402 enters the vessel, and an output port 410 may be where the lunar dust exits the vessel.

Pump 400 may include electronics 412 to, among other things, sequentially energize electrodes 406. Such sequential energizing is described below. Each electrode 406 may be activated (e.g., holding an electrical potential (voltage)) to produce an electric field flux that imparts a Coulomb force on each charged particle of lunar dust 402. As described below, activation of the electrodes may be performed in a sequence so that some of the electrodes are activated while others are not. For example, electronics 412 may include circuitry that sequentially and cyclically applies, via lines A, B, C, and D, a voltage first to electrode E1, subsequently to electrode E2, subsequently to electrode E3, and subsequently to electrode E4. Electronics 412 may include timing circuits to allow for particular time spans during which each of the electrodes E1-E4 are energized and to allow for overlap or time gaps among the time spans, as described below. Such time spans, timing overlap, and time gaps may be adjustable. For example, electronics 412 may be configured to vary how long a first electrode and a second electrode are energized based, at least in part, on flow speed of charged lunar dust 402. Electronics 412 may also be configured to apply a voltage (e.g., a grounding voltage) sufficient to de-activate the electrodes. For example, the electronics may be configured to reverse the sequence of energizing a first electrode and a second electrode to stop or reverse direction of flow of the charged lunar dust.

In some implementations, an electrode screen 412 may be disposed at input port 408 of vessel 404. The electrode screen may be configured to electrostatically attract and transmit individual particles 414 of charged lunar dust from outside the vessel to inside the vessel. The individual particles may originate from a larger mass of lunar dust 416. When input port 408 is placed relatively close to such a mass of lunar dust, and electrode screen 412 holds a positive charge (e.g., with a positive voltage), a Coulomb force may attract and accelerate negatively charged dust particles toward electrode screen 412. Because of the accelerated particles'momentum at the electrode screen (which is the source of the attraction), the dust particles may likely pass through openings 418 of the electrode screen, while a portion of the particles will collide with the electrode screen. These passing dust particles may then be attracted to a subsequent positively charged electrode, which may be electrode E1, for example. Dust particles that collided and stuck to the electrode screen may be released from the electrode screen and pulled toward electrode E1 when the voltage on the electrode screen is removed and a positive voltage is placed on electrode E1. Accordingly, in some implementations, the voltage applied to electrode screen 412 may be pulsed repeatedly from zero to a positive voltage and such pulses may be coordinated with a positive voltage applied to electrode E1. For example, as just mentioned, electronics 412 may be configured to energize electrode screen 412 and electrode E1 sequentially such that electrode E1 electrostatically attracts charged lunar dust from the electrode screen toward electrode E1.

In some embodiments, electrostatic pump 400 may be used to generate thrust in a propulsion system. The thrust may arise from charged lunar dust 402 accelerated by electrodes 406. For example, the series of electrodes 406 located along a length of vessel 404 may be configured to be sequentially energized to apply electrostatic forces on the charged lunar dust to accelerate the charged lunar dust in a direction 420 from input port 408 to output port 410. The individual electrodes of the series of electrodes may be progressively longer in direction 420, wherein the increasing length of the individual electrodes corresponds to the acceleration of the charged lunar dust. For example, electrode E2 is longer than electrode E1 but shorter than electrode E3 and electrode E4 is longer than electrode E3 but shorter than an electrode E1′. In some implementations, electrostatic pump 400 may include focusing electrodes or electromagnetic coils at or near output port 410 of vessel 404. Applying a carefully shaped electric or magnetic field to the accelerated charged lunar dust may lead to a focused jet of the charged lunar dust, for example. In some implementations, electrostatic pump 400 may include a magnetometer to measure the magnitude of a magnetic field created by flow of the accelerated charged lunar dust. The series of electrodes may be configured to be sequentially energized with time spans that are based, at least in part, on the magnitude of a magnetic field.

In various embodiments, electrostatic pump 400 may be used for a variety of applications. For example, the electrostatic pump may be used to generate thrust, as just described. Another application of an electrostatic pump that is the same as or similar to 400 may be to produce a construction material by combining the stream of charged lunar dust and a melding material, such as in the example embodiments described for FIGS. 1-3. In still another application, a stream of charged lunar dust produced by electrostatic pump 400 may be used as a spray that may be applied to an output region 422, which may be a surface or a collecting vessel (not illustrated), for example. Such an application may be useful for removing lunar dust from one location (e.g., lunar dust 416 at input port 408) and storing the removed lunar dust in a holding container. Such a process may be similar in function to a vacuum cleaner, for example.

FIG. 5 is a schematic cross-section view of a sequence of energizing the series of electrodes 406 for electrostatically pumping charged lunar dust, according to some embodiments. As in FIG. 4, each of electrodes 406 are individually labelled E1, E2, E3, and E4. Energized electrodes hold a voltage, which comprises an electric charge that give rise to an electric field. If an electrode is not holding a voltage, e.g., is at a ground potential or zero volts and thus not energized, then the electrode will not give rise to an electric field.

At Time A, electronics 412 applies a voltage to electrode E1 to energize this electrode. As a result, electrode E1 produces an electric field. Simultaneously, electrodes E2, E3, and E4 are not energized and thus do not produce an electric field. An interaction between the electric field of electrode E1 and charged lunar dust in the electric field is schematically illustrated by arrows 502, which indicate a general direction of attraction and thus flow of the charged lunar dust. This example snapshot of time (Time A) demonstrates that charged lunar dust 402 may be conveyed, in this example, toward the right of the figure by an applied electric field. A subsequent snapshot of time, however, would reveal that the charged lunar dust would soon cease to flow and instead “gather” near electrode E1. To avoid this, and to convey charged lunar dust 402 further to the right, electronics 412 deenergizes electrode E1 so the electrode no longer produces an electric field. For example, electronics 412 may neutralize (e.g., ground) the voltage applied to electrode E1.

Substantially while deenergizing electrode E1, electronics 412 applies a voltage to electrode E2 to energize this electrode. As a result, only electrode E2 produces an electric field. In addition to E1, electrodes E3 and E4 are also not energized and thus do not produce an electric field. These conditions occur during Time B.

An interaction between the electric field of electrode E2 and charged lunar dust 402 is schematically illustrated by arrows 504, which indicate a general direction of attraction and, thus, flow of the charged lunar dust. This example snapshot of time (Time B) demonstrates that the charged lunar dust may be “pulled away” from the previous electric field of electrode E1, which no longer exists, and pulled toward the electric field of electrode E2. Thus, the charged lunar dust may be conveyed further toward the right of the figure by an applied electric field (of electrode E2). As before, however, a subsequent snapshot of time would reveal that the charged lunar dust would soon cease to flow and instead “gather” near electrode E2. To avoid this, and to again convey charged lunar dust 402 further to the right, electronics 412 deenergizes electrode E2 so the electrode no longer produces an electric field. Substantially while deenergizing electrode E2, electronics 412 applies a voltage to electrode E3 to energize this electrode. As a result, only electrode E3 produces an electric field. In addition to E2, electrodes E1 and E4 are also not energized and thus do not produce an electric field. These conditions occur during Time C.

An interaction between the electric field of electrode E3 and the charged lunar dust is schematically illustrated by arrows 506, which indicate a general direction of attraction and, thus, flow of charged lunar dust 402. This example snapshot of time (Time C) demonstrates that charged lunar dust 402 may be “pulled away” from the previous electric field of electrode E2, which no longer exists, and pulled toward the electric field of electrode E3. Thus, the charged lunar dust may be conveyed further toward the right of the figure by an applied electric field (of electrode E3). As before, however, a subsequent snapshot of time would reveal that the charged lunar dust would soon cease to flow and instead “gather” near electrode E3. To avoid this, and to once again convey charged lunar dust 402 further to the right, electronics 412 deenergizes electrode E3 so the electrode no longer produces an electric field. Substantially while deenergizing electrode E3, electronics 412 applies a voltage to electrode E4 to energize this electrode. As a result, only electrode E4 produces an electric field. In addition to E3, electrodes E1 and E2 are also not energized and thus do not produce an electric field. These conditions occur during Time D.

An interaction between the electric field of electrode E4 and the charged lunar dust is schematically illustrated by arrows 508, which indicate a general direction of attraction and, thus, flow of charged lunar dust 402. This example snapshot of time (Time D) demonstrates that charged lunar dust 402 may be “pulled away” from the previous electric field of electrode E3, which no longer exists, and pulled toward the electric field of electrode E4. Thus, the charged lunar dust may be conveyed further toward the right of the figure by an applied electric field (of electrode E4). As before, however, a subsequent snapshot of time would reveal that the charged lunar dust would soon cease to flow and instead “gather” near electrode E4. To avoid this, and to once again convey charged lunar dust 402 further to the right, electronics 412 deenergizes electrode E4 while starting to apply a voltage to a subsequent electrode (e.g., E1′ illustrated in FIG. 4) in pump 400. The above-described cycle may continue for each of subsequent electrodes in the pump.

In some embodiments, electronics 412 may apply a voltage to more than one electrode at any given time. In other words, multiple electrodes of pump 400 may be simultaneously energized to produce their respective electric fields. A condition for such a presence of simultaneous electric fields, however, may be that each of these electric fields are spaced apart by distances that are large enough to avoid substantial overlap of the respective fields. This condition assures that each portion of charged lunar dust 402 will not be substantially attracted to the electric field of more than one electrode at a time. Generally, the strength of an electric field decreases with increasing distance from the electrodes. Thus, for example, electronics 412 may energize both electrodes E1 and E4 simultaneously if their respective electric fields don't substantially overlap. If they did overlap, then some portions of charged lunar dust 402 may flow toward the left of the figure while other portions would flow toward the right. On the other hand, if there is no substantial overlap, then the electric fields of both electrodes E1 and E4 may reinforce their “pumping” effect on the rightward flow of the charged lunar dust.

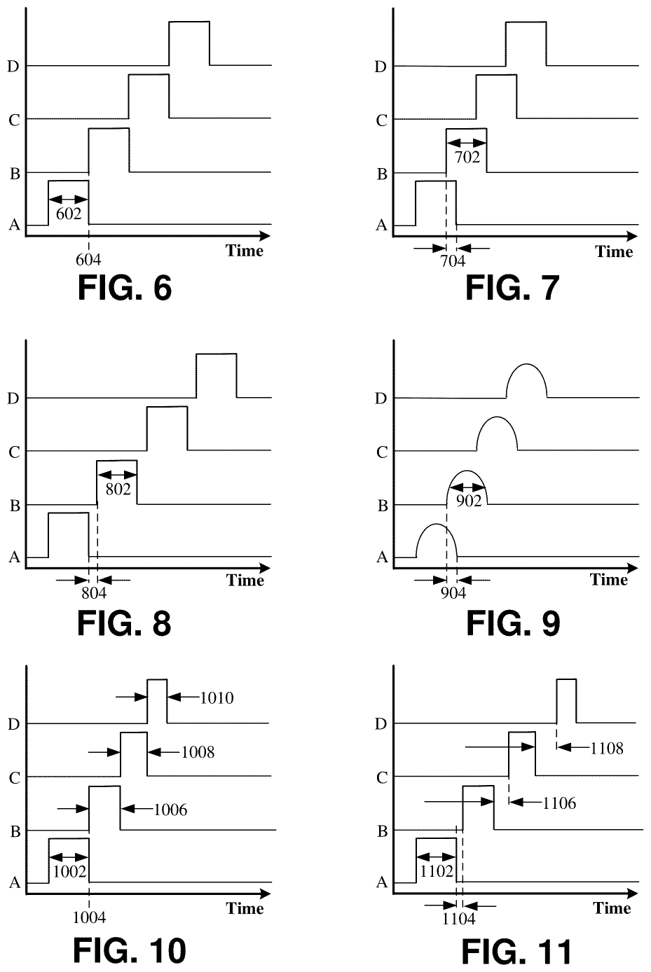

FIGS. 6-11 are timing diagrams of voltages applied to electrodes for electrostatically pumping negatively charged lunar dust, according to some embodiments.

FIG. 6 is a timing diagram for voltages applied (e.g., by electronics 412) to electrodes 406 of pump 400, according to some embodiments. In this example, each of electrodes 406 is momentarily energized by a square pulse having a duration 602. In particular, electrode E1 is energized for a duration 602 to produce an electric field. At time 604, at the end of duration 602, voltage is no longer applied to electrode E1 when voltage is applied to electrode E2. Similarly, voltage is no longer applied to electrode E2 when voltage is applied to electrode E3, and voltage is no longer applied to electrode E3 when voltage is applied to electrode E4. Thus, occurrences of electric fields of the respective electrodes do not overlap and only one of the electrodes is producing an electric field at any given time (at least in the illustrated section of pump 400). In some implementations, electronics 412 may allow for adjustments of duration 602 so as to “optimize” or change the performance of pump 400. Also, electronics 412 may be configured to vary the frequency or time period that electrodes 406 are sequentially energized based, at least in part, on flow speed of the lunar dust in pump 400. In another example, electronics 412 may be configured to reverse the sequence (e.g., from A, B, C, D . . . to . . . D, C, B, A) of energizing electrodes 406 to stop or reverse direction of flow of the lunar dust.

FIG. 7 is a timing diagram for voltages applied to electrodes 406 of lunar dust pump 400, according to other embodiments. In this example, each of electrodes 406 is momentarily energized by a square pulse having a duration 702. In particular, electrode E1 is energized for a duration 702 to produce an electric field. There is a time overlap of duration 704 during which voltage is applied to both electrodes E1 and E2. Similarly, such a time overlap of duration 704 also occurs during which voltage is applied to both electrodes E2 and E3, and a time overlap of duration 704 occurs during which voltage is applied to both electrodes E3 and E4. Thus, occurrence of electric fields of two adjacent electrodes overlap and these two electrodes produce their respective electric fields during this time overlap. In some implementations, electronics 412 may allow for adjustments of each of duration 702 and 704 so as to “optimize” or change the performance of pump 400.

FIG. 8 is a timing diagram for voltages applied to electrodes 406 of lunar dust pump 400, according to still other embodiments. In this example, each of electrodes 406 is momentarily energized by a square pulse having a duration 802. In particular, electrode E1 is energized for a duration 802 to produce an electric field. There is a time delay of duration 804 between when voltage is not applied to electrodes E1 and when voltage is applied to electrode E2. Similarly, such a time delay of duration 804 also occurs between energizing of electrodes E2 and E3, and between electrodes E3 and E4. During these delays, no voltage is applied to the electrodes and no electric field is present. (Herein, it is to be understood that “no applied voltage” may include a situation wherein a trivially small amount of voltage may exist on an electrode but is a small enough voltage so as to result in less than a weak or negligible electric field.) In some implementations, electronics 412 may allow for adjustments of each of duration 802 and delay 804 so as to “optimize” or change the performance of pump 400.

FIG. 9 is a timing diagram for voltages applied to electrodes 406 of lunar dust pump 400, according to still other embodiments. In this example, each of electrodes 406 is momentarily energized by a time-varying (e.g., non-square) pulse having a duration (e.g., FWHM, full width at half max) 902. In other examples, in place of the pulse shape illustrated in FIG. 9, such a time-varying pulse may be sinusoidal, saw-tooth, ramp, exponential decay/increase, as well as numerous other waveform shapes, which may be tuned to “optimize” or change the performance of pump 400. In particular, electrode E1 is energized for a duration 902 to produce an electric field. There is a time overlap of duration 904 during which voltage is applied to both electrodes E1 and E2. Similarly, such a time overlap of duration 904 also occurs during which voltage is applied to both electrodes E2 and E3, and a time overlap of duration 904 occurs during which voltage is applied to both electrodes E3 and E4. Thus, occurrence of electric fields of two adjacent electrodes overlap and these two electrodes produce their respective electric fields during this time overlap. In some implementations, electronics 412 may allow for adjustments of each of duration 902 and 904 so as to “optimize” or change the performance of pump 400. In some embodiments, any combination of conditions or parameters of energizing waves forms illustrated in FIGS. 6-9 may be used to operate pump 400, and claimed subject matter is not limited to any particular energizing scheme.

FIG. 10 is a timing diagram for voltages applied (e.g., by electronics 412) to electrodes 406 of lunar dust pump 400, according to some embodiments. In this example, each of electrodes 406 is momentarily energized by a square pulse having consecutively diminishing durations. In particular, electrode E1 is energized for a duration 1002 to produce an electric field. At time 1004, at the end of duration 1002, voltage is no longer applied to electrode E1 when voltage is applied to electrode E2 for a duration 1006, which is less than duration 1002. Voltage is no longer applied to electrode E2 when voltage is applied to electrode E3 for a duration 1008, which is less than duration 1006, and voltage is no longer applied to electrode E3 when voltage is applied to electrode E4 for a duration 1010, which is less than duration 1008. Thus, occurrence of electric fields of the respective electrodes do not overlap and only one of the electrodes is producing an electric field at any given time. In some implementations, electronics 412 may allow for adjustments of durations 1002, 1006, 1008, and 1010 so as to “optimize” or change the performance of pump 400. Also, electronics 412 may be configured to vary the frequency or time period that electrodes 406 are sequentially energized based, at least in part, on flow speed of the lunar dust in pump 400. In another example, electronics 412 may be configured to reverse the sequence (e.g., from A, B, C, D. . . to . . . D, C, B, A) of energizing electrodes 406 to stop or reverse direction of flow of the lunar dust.

FIG. 11 is a timing diagram for voltages applied to electrodes 406 of pump 400, according to still other embodiments. In this example, each of electrodes 406 is momentarily energized by a square pulse having consecutively diminishing durations, similar to that illustrated in FIG. 10. For example, electrode E1 is energized for a duration 1102 to produce an electric field. Subsequent electrodes may be energized with shorter pulse durations. In contrast to the pulse sequence illustrated in FIG. 10, there is a time delay of duration 1104 between when voltage is no longer applied to electrode E1 and when voltage is applied to electrode E2. Similarly, a time delay of duration 1106, which may be greater than duration 1104, also occurs between energizing of electrodes E2 and E3. A time delay of duration 1108, which may be greater than duration 1106, also occurs between electrodes E3 and E4. During these delays, no voltage (or very small voltage) is applied and substantially no electric field is present. In some implementations, electronics 412 may allow for adjustments of each of delays 1104, 1106, and 1108 and duration 1102 so as to “optimize” or change the performance of pump 400. For example, delays 1104, 1106, and 1108 and/or duration 1102 may be adjusted based on measurements of a magnetometer that measures the strength of a magnetic field created by the moving charged dust particles.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments or examples are presented by way of examples for purposes of illustration and description. They are not intended to be exhaustive of or to limit this disclosure to the precise forms described. Many modifications and variations are possible in view of the above teachings. The embodiments or examples are shown and described in order to best explain the principles of this disclosure and practical applications, to thereby enable others skilled in the art to best utilize this disclosure and various embodiments or examples with various modifications as are suited to the particular use contemplated. It is intended that the scope of this disclosure be defined by the following claims and their equivalents.

We claim as follows:

1. An electrostatic pump system for producing and guiding a stream of charged particulate matter into a material fabricating region, the electrostatic pump system comprising:
a vessel for conveying the charged particulate matter, the vessel including an input port and an output port for the charged particulate matter;
a first electrode and a second electrode located along a length of the vessel, the first electrode located closer than the second electrode to the input port, and the second electrode located closer than the first electrode to the output port; and
electronics to successively energize the first electrode and the second electrode such that i) the first electrode, when energized, applies a force on the charged particulate matter to convey the charged particulate matter from the input port of the vessel and toward the first electrode, and ii) the second electrode, when energized, applies a force on the charged particulate matter to convey the charged particulate matter away from the first electrode and toward the output port of the vessel,
wherein the material fabricating region is located at the output port of the vessel and is configured to facilitate a solidification of the stream of the charged particulate matter via an interaction between the stream of the charged particulate matter and a melding material or electromagnetic radiation.

2. The electrostatic pump system of claim 1, further comprising a nozzle to output the melding material, wherein the melding material is a polymer.

3. The electrostatic pump system of claim 1, further comprising a microwave emitter, wherein the electromagnetic radiation comprises microwave radiation.

4. The electrostatic pump system of claim 1, further comprising a laser to produce the electromagnetic radiation.

5. The electrostatic pump system of claim 1, further comprising focusing electrodes at the output port of the vessel, the focusing electrodes configured to focus the stream of the charged particulate matter.

6. The electrostatic pump system of claim 1, further comprising an electrode screen at the input port of the vessel, the electrode screen configured to electrostatically attract and transmit the charged particulate matter from outside the vessel to inside the vessel.

7. The electrostatic pump system of claim 6, wherein the electronics are configured to energize the electrode screen, the first electrode, and the second electrode sequentially such that the first electrode electrostatically attracts the charged particulate matter from the electrode screen toward the first electrode.

8. The electrostatic pump system of claim 1, wherein the electronics are configured to vary how long the first electrode and the second electrode are energized based, at least in part, on flow speed of the charged particulate matter.

9. The electrostatic pump system of claim 1, wherein the electronics are configured to reverse the sequence of energizing the first electrode and the second electrode to stop or reverse direction of flow of the charged particulate matter.

10. A material fabrication system comprising:
an electrostatic pump system configured to produce a stream of charged particulate matter, wherein the electrostatic pump system includes
a vessel for conveying the particulate matter, the vessel including an input port and an output port for the charged particulate matter, and
a series of electrodes located along a length of the vessel, wherein the series of electrodes are configured to be energized to apply electrostatic forces on the charged particulate matter; and
to fabricate the material, i) a dispenser at the output port to provide a melding material to the stream of the charged particulate matter or ii) a microwave emitter at the output port to radiate the stream of the charged particulate matter.

11. The material fabrication system of claim 10, wherein the melding material is a polymer.

12. The material fabrication system of claim 10, wherein the melding material is positively charged to substantially neutralize the charged particulate matter.

13. The material fabrication system of claim 10, wherein the electrostatic pump system further includes focusing electrodes at the output port of the vessel, the focusing electrodes configured to focus the stream of the charged particulate matter.

14. The material fabrication system of claim 10, wherein the electrostatic pump system further includes an electrode screen at the input port of the vessel, the electrode screen configured to electrostatically attract and transmit the charged particulate matter from outside the vessel to inside the vessel.

15. An electrostatic pump system for producing a jet of charged particulate matter, the electrostatic pump system comprising:
a vessel for accelerating the charged particulate matter, the vessel including an input port and an output port for the charged particulate matter; and
a series of electrodes located along a length of the vessel, wherein the series of electrodes are configured to be sequentially energized to apply electrostatic forces on the charged particulate matter to accelerate the charged particulate matter in a direction from the input port to the output port, wherein individual electrodes of the series of electrodes are progressively longer in the direction from the input port to the output port, the increasing length of the individual electrodes corresponding to the acceleration of the charged particulate matter.

16. The electrostatic pump system of claim 15, further comprising focusing electrodes at the output port of the vessel, the focusing electrodes configured to focus the accelerated charged particulate matter to form the jet of the charged particulate matter.

17. The electrostatic pump system of claim 15, further comprising focusing electromagnets at the output port of the vessel, the focusing electromagnets configured to focus the accelerated charged particulate matter to form the jet of the charged particulate matter.

18. The electrostatic pump system of claim 15, further comprising an electrode screen at the input port of the vessel, the electrode screen configured to electrostatically attract and transmit the charged particulate matter from outside the vessel to inside the vessel.

19. The electrostatic pump system of claim 15, further comprising an electronic control system to vary lengths of time that the individual electrodes of the series of electrodes are energized based, at least in part, on flow speed of the charged particulate matter.

20. The electrostatic pump system of claim 15, further comprising a magnetometer to measure magnitude of a magnetic field created by flow of the charged particulate matter, wherein the series of electrodes are configured to be sequentially energized with time spans that are based, at least in part, on the magnitude of a magnetic field.
